(19) United States
(12) Patent Application Publication
(10) Pub. No.: US 2008/0271101 A1
(43) Pub. Date: Oct. 30, 2008

(54) SYSTEM AND METHOD FOR BROADBAND DIGITAL VIDEO RECORDING

(75) Inventor: Sean Paul Doherty, Los Gatos, CA (US)

Correspondence Address: FENWICK & WEST LLP, SILICON VALLEY CENTER, 801 CALIFORNIA STREET, MOUNTAIN VIEW, CA, 94041, US

(73) Assignee: SHORELINE ASSOCIATES X, LLC, Palo Alto, CA (US)

(21) Appl. No.: 12/106,172

(22) Filed: Apr. 18, 2008

Related U.S. Application Data
(60) Provisional application No. 60/913,583, filed on Apr. 24, 2007.

(51) Int. Cl. H04N 7/173

(52) U.S. Cl. 725/114

(57) ABSTRACT

A broadband digital video recorder (BDVR) system allows cable or satellite television (TV) viewers to cause a copy of a selected TV show to be downloaded via a broadband Internet network and stored for viewing on a designated computer or a portable media player. Television viewers make a selection of a TV show to record using their remote control device. In response, the BDVR system causes a copy of a video file corresponding to the selected television show to be automatically downloaded from a remote server to the user's computer over a broadband Internet connection. Users may conveniently select a television show to record via a conventional television network but automatically download a digital video file corresponding to the television show to their computer via a broadband Internet network without complicated user interaction and without searching for the video files on the Internet.

### CROSS-REFERENCE TO RELATED APPLICATION

This application claims priority under 35 U.S.C. §119(e) from co-pending U.S. Provisional Patent Application No. 60/913,583 entitled “Broadband Digital Video Recorder,” filed on Apr. 24, 2007, which is incorporated by reference herein in its entirety.

### BACKGROUND OF THE INVENTION

1. Field of the Invention

The present invention relates to downloading, storing, and thereafter managing access to and playback of video.

2. Description of the Related Art

Conventional digital video recorders (DVRs) are used to store television shows broadcast to a television over air or via a set top box used with a cable (or satellite) television (TV) network. The television shows are stored typically on a storage device such as a hard disk drive in the DVRs. More recently, DVRs are sometimes incorporated into the set top box used to receive digital television signals from a cable television network or satellite television network.

Conventional DVRs are not designed to download video files from sources other than the television service provider through the cable television network or satellite television network or standard public television network. Also, conventional DVRs are typically dedicated video recording devices and do not have the versatile capabilities of a general purpose computer or a portable media player.

### SUMMARY OF THE INVENTION

Embodiments of the present invention include a computer-implemented method of providing a broadband DVR (“BDVR”) service to subscribers of a cable (or satellite) television service. The BDVR system of the present invention allows cable or satellite TV viewers to cause a copy of a selected TV show to be stored (“recorded”) for viewing on a designated computer or a portable media player. Television viewers make a selection of a TV show to record using their remote control device through a television network. In response, the BDVR system causes a copy of a video file corresponding to the selected television show to be located and made available for (automatic) download from a remote server to the user's computer over a broadband Internet connection.

In one embodiment, a computer-implemented method of downloading a video file is provided at a first computer, wherein the method comprises receiving at the first computer a selection of a television show to record, determining a location of a second computer at which the video file corresponding to the television show is stored, and transmitting the location of the second computer from the first computer to a third computer for the third computer to download the video file from the second computer to the third computer, the third computer being remote from the first computer and from the second computer. In one embodiment, the video file is downloaded from the second computer to the third computer via a broadband Internet network.

The BDVR service according to the present invention enables users to conveniently select a television show they would like to record via a conventional television network but automatically download a digital video file corresponding to that television show to their computer or portable media player via a broadband Internet network without complicated user interaction. The users can conveniently record and play the video file on their computers without having to search for the video files on the Internet.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present invention can be readily understood by considering the following detailed description in conjunction with the accompanying drawings.

FIG. 1 illustrates the architecture of a broadband digital video recorder (BDVR) system according to one embodiment of the present invention.

FIG. 2 is an interaction diagram illustrating a method of registering a user to the BDVR system according to one embodiment of the present invention.

FIG. 3 is an interaction diagram illustrating a method of downloading a video file corresponding to a television show to be recorded using the BDVR system according to one embodiment of the present invention.

### DETAILED DESCRIPTION OF EMBODIMENTS

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

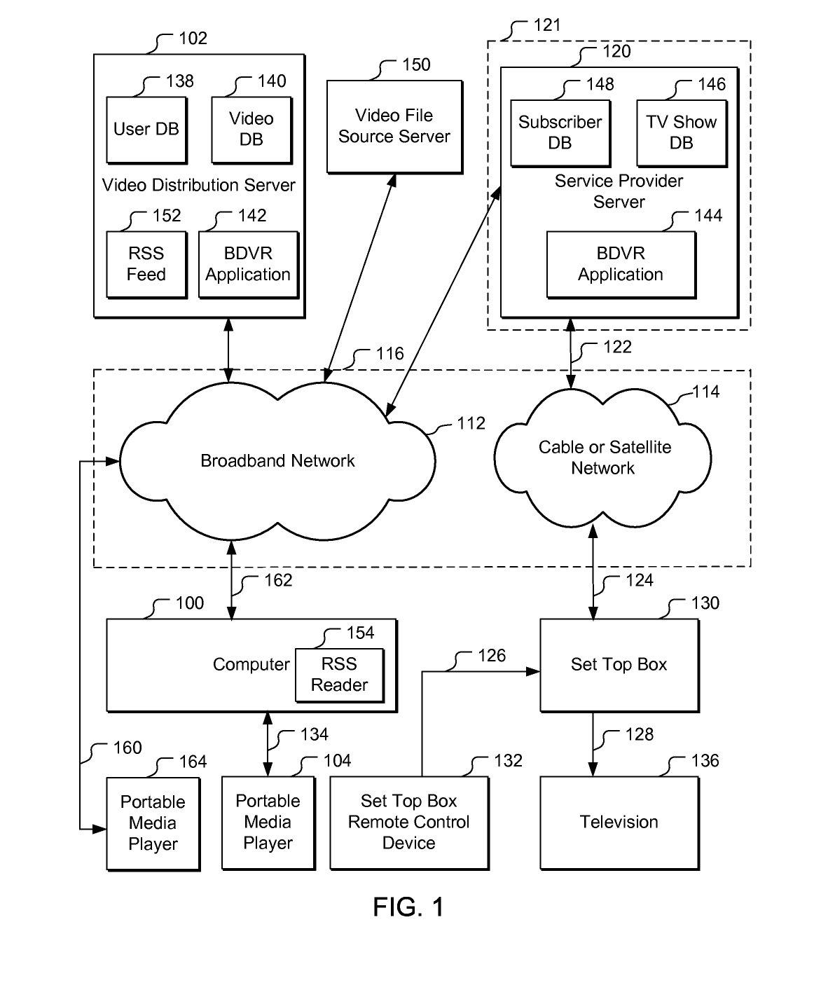

The BDVR system of the present invention allows cable or satellite TV viewers to cause a copy of a selected TV show to be downloaded through a broadband Internet connection and stored (“recorded”) for viewing on a designated computer or a portable media player. FIG. 1 illustrates the architecture of the broadband digital video recorder (BDVR) system according to one embodiment of the present invention. The BDVR system includes a video distribution server 102, a service provider server 120, a BDVR user computer 100, a set top box 130, a set top box remote control device 132, and one or more video file source server(s) 150. Portable media players 104, 164 may additionally be used with the computer 100, and a television 136 is used with the set top box 130 to view television shows. The user computer 100 may be remote from the video distribution server 102 and the video file source server 150. In addition, the video distribution server 102 may be remote from the video file source server 150.

The service provider server 120 communicates with the set top box 130 via a cable (or satellite) television network 114. The video distribution server 102, the service provider server 120, the video file source server 150, and the computer 110 can communicate with one another over the Internet via a broadband network 112, although they can communicate via other type of communication networks in other embodiments. In addition, portable media player 164 may also communicate with the computer 110 through the broadband network 112. In addition, in another embodiment, the broadband network 112 and the cable television network 114 may be combined and be part of a single type of communication network 116.

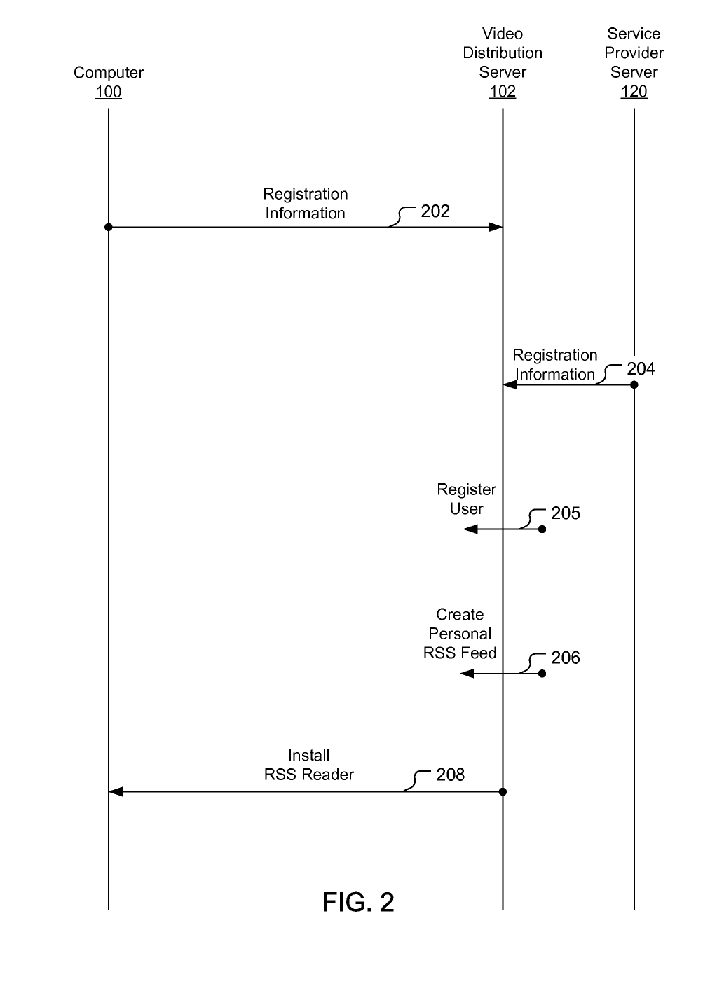

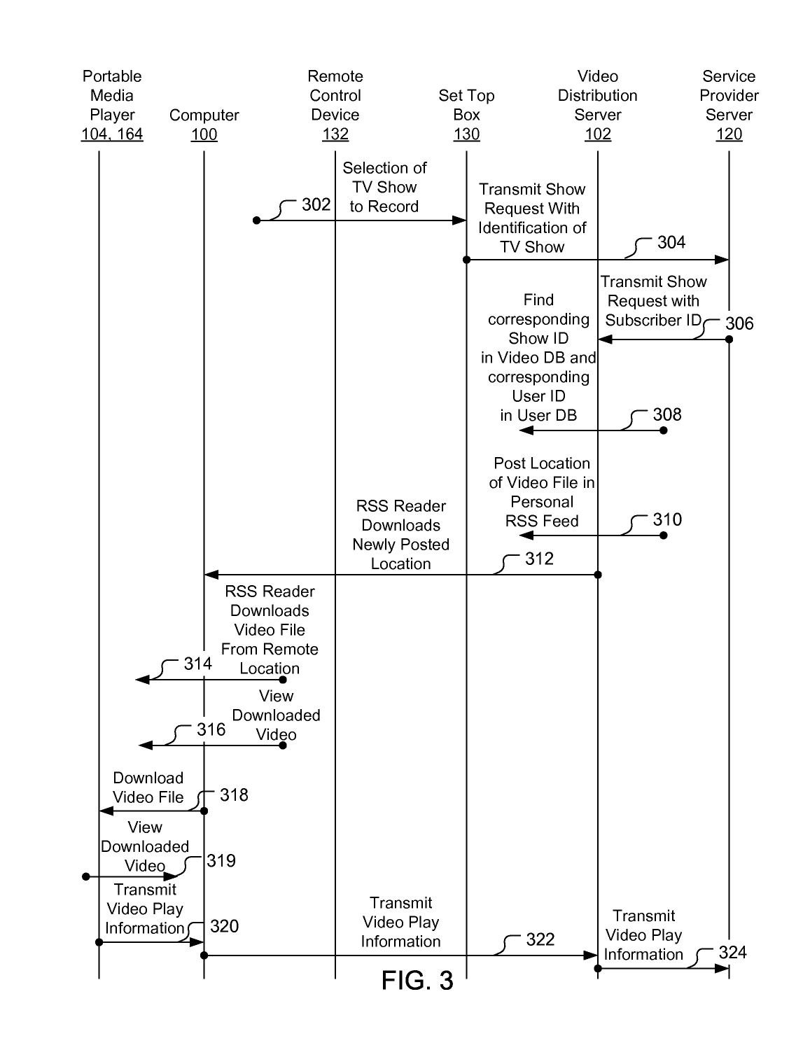

The head-end 121 is the central facility of a cable (or satellite) TV service provider. The head-end 121 includes the service provider server 120. The service provider server 120 includes a subscriber database 148, a television show database 146, and a BDVR application 144. The subscriber database 148 stores a list of the television service subscribers together with a variety of identification information (e.g., name, address, subscriber ID, set top box ID, etc.) and any other information associated with the subscribers. For example, the subscriber database 148 may also store a list of subscribers who have also been authorized to use the BDVR service. The television show database 146 stores a list of the television shows available for recording in the BVDR system. The television show database 146 may also store video files corresponding to the television shows themselves in other embodiments for future downloading by the BDVR users. The BDVR application 144 is a software application running on the service provider server 120, and manages the interaction of the service provider server 120 with the video distribution server 102, as is described below in more detail with reference to FIGS. 2 and 3. The head-end 121 and the service provider server 120, as well as the set top box 130, are coupled to a cable (or satellite) TV network 114. The head-end 121 provides television shows in the form of digital video signals to the cable (or satellite) set top box 130 via the cable (or satellite) TV network 114 in a conventional manner, so that the television service subscriber can view the television shows on the television set 136. The television service subscriber herein is also a subscriber to the BDVR system, according to one embodiment of the present invention.

A standard remote control device 132 is used to control the operations of the set top box 130 via infrared (IR) or radio frequency (RF) connection 126 in a conventional manner. As will be described in more detail below with reference to FIG. 3, the remote control device 132 includes a record button (not shown) that causes a selected television show or multiple TV shows to be recorded by the BDVR system according to one embodiment of the present invention. In another embodiment, the remote control device 132 may be operable with the menu system of a conventional DVR to select a television show to be recorded.

The video distribution server 102 is a standard server computer, and is connected to a broadband network 112 for Internet connection. The video distribution server 102 includes a user database 138, a video database 140, and a BDVR application 142, all of which may be stored on a computer readable storage medium such as a hard disk (not shown herein) or solid state memory (not shown herein). The user database 138 stores a list of users of the BDVR system together with other information (e.g., user ID) associated with the users. The video database 140 stores a list of video files corresponding to a variety of television shows available for downloading from one or more video file source servers 150, together with the locations (e.g., uniform resource locators, or URLs) of those video file source servers 150. The video database 140 can be compiled by manual input or by automatic search of such sources by the video distribution server 102. For example, the video database 140 may be compiled through an administrative interface through which any Internet-connected computer may be authorized to make additions or changes to the video database 140. In some implementations, authorization to the video database 140 may be granted to only certain users, editors, employees, television programmers, and the like. The BDVR application 142 is a software application running on the video distribution server 102, manages the interaction of the video distribution server 102 with the service provider server 120 and the computer 100, and creates and updates an RSS feed 152 for downloading of video files to the user computer 100, as is described below in more detail with reference to FIGS. 2 and 3. The BDVR application 142 may be implemented as a computer program product running on a processor (not shown herein) of the video distribution server 102. Although in the embodiment shown in FIG. 1 the video distribution server 102 is shown as residing remotely from the service provider server 120 and/or operated by a different entity, in other embodiments the video distribution server 102 may be operated by the same entity as the head-end 121 or may be combined together with the service provider server 120 as a single server. For example, a cable television operator may also provide the BDVR services with the video distribution server 102. In such case, the service provider server 120 may not have to communicate with the video distribution server 102 via an Internet broadband connection, and may simply communicate with the video distribution server 102 via a local area network (LAN) or other communication networks.

The computer 100 can be any type of general purpose computer, and communicates with the video distribution server 102 via an Internet connection over the broadband network 112. As will be described in more detail below with reference to FIG. 3, when the record function of the BDVR system is activated, the RSS feed 152 (e.g., Really Simple Syndication for RSS 2.0) running on the video distribution server 102 posts an update to the personal RSS feed 152 established for each registered BDVR user. The RSS reader 154 running on the computer 110 periodically checks the personal RSS feed 152 and retrieves any updates. The RSS update includes a location (e.g., URL) of a video file source server computer(s) 150 that stores a video file corresponding to the television show(s) selected for recording. In response, the RSS reader 154 downloads the video file from the video file source server(s) 150, so that the user can play the video file and view the television show using conventional video player software (not shown) running on the computer 100. The video player software may be independent software, or may be included in the RSS reader 154 itself Although the example of an RSS feed 152 and RSS reader 154 are used herein to illustrate how the location of the video file source servers 150 is provided to the computer 100 for downloading of the video file, note that any other type of Internet standard or proprietary method for subscribing to and automatically receiving data transmission may be used herein to receive the location of the video file source servers 150 and download the video file. For example, Atom is another type of Internet standard that can be used to provide the location of the video file source servers 150 to the computer 100 for downloading of the video file. For another example, a simple email may be used to provide the location of the video file source servers 150 to the computer 100 for downloading of the video file.

The portable media players 104, 164 may be any type of media player device, such as a personal digital assistant, a smartphone (including both computing functions and cellular telephone functions), a media player (e.g., a video player), a cellular telephone with some computing functionality, and the like. The video file may also be transferred or “streamed” from the computer 100 to the portable media player 104 using conventional synchronization techniques over a communication link 134 (e.g., a Universal Serial Bus (USB) link), so that the video file may be played on the portable media player 104. In addition, the video file may be transferred or “streamed” from the computer 100 to the portable media player 164 via the broadband Internet network 112 through the links 162, 160, so that the video file may be downloaded remotely from the computer 100 and played on the portable media player 164. In either case where the portable media player 104, 164 is used, the computer 100 may be viewed as functioning as an intermediate storage server for access to the video files by the portable media players 104, 164.

FIG. 2 is an interaction diagram illustrating a method of registering a user to the BDVR system according to one embodiment of the present invention. In order for a user to use the BDVR system, the user must first register with the BDVR system. Registration of the user may be accomplished through an Internet web site in one embodiment. In another embodiment, a cable/satellite television system operator may register a user to the BDVR system through the television system operator's internal customer management system.

Referring to both FIGS. 1 and 2, user registration information is provided 202 from the user's computer 100 to the video distribution server 102, for example, via an Internet web site. This illustrates the situation where the BDVR user manually registers to the BDVR system using an Internet connection 112 to a web site managed by the BDVR application of the video distribution server 102. Alternatively, the user registration information may be provided 204 from the service provider server 120 to the video distribution server 102. This illustrates the case when the cable/satellite television system operator registers its subscribers as users to the BDVR system through the television system operator's internal customer management system. User registration information may include a unique user ID for each user, a password or other authentication data, and customer information such as name, address, contact information, demographics information, and the like.

In one embodiment, the user ID is a unique username for use only with the BDVR system and different from a subscriber ID used with the head-end 121. In such case, the head-end 121 and the BDVR service operator operating the video distribution server 102 would cooperate to share the head-end's subscriber information with the BDVR service operator, so that the subscriber ID of the head-end 121 can be matched with a user ID of the BDVR system. In another embodiment, the user ID may be an identifier that is shared between the cable/satellite operator and the BDVR system, such that the BDVR system's user ID is identical to the subscriber ID maintained in the cable (or satellite) television system. In such case, the BDVR's user database 138 may be automatically populated with subscriber information collected by the cable/satellite operator, and the subscriber ID for the head-end 121 is identical to the user ID for the video distribution server 102 of the BDVR system.

Once the registration information is received 202, 204, the video distribution server 102 (the BDVR application 142) registers 205 the BDVR user by assigning the user ID to the user and storing the registration information in the user database 138. Then, the video distribution server 102 (the BDVR application 142) creates 206 a personal RSS feed 152 corresponding to the user. In one embodiment, the name of the RSS feed 152 identifies both the cable/satellite service provider and the DVR system user (e.g. “Comcast.BrianRoberts.feed” or “DirecTV.JohnMalone.feed”). The RSS feed 152 is used to deliver requested video content to the user's computer 100. In addition, the video distribution server 102 (the BDVR application 142) causes the RSS reader 152 to be installed 208 on the computer 100 via communication over the broadband network 112. The RSS reader 154 manages the user's video downloads to the computer 100. In some embodiments, the RSS reader 154 also includes an integrated video player, and may incorporate the “synchronization” functions for copying files from the computer 100 to the portable media player 104.

FIG. 3 is an interaction diagram illustrating a method of downloading a video file corresponding to a television show to be recorded using the BDVR system, according to one embodiment of the present invention. Referring to FIGS. 1 and 3, a cable (or satellite) TV subscriber selects 302 a television show to be recorded by the BDVR system using the remote control device 132, and such selection of the TV show is sent from the remote control device 132 to the step top box 130. In this regard, the cable (or satellite) subscriber may, while watching a TV show, press a “Record” button on the remote control 132 to request that the TV show be recorded. The cable (or satellite) subscriber may also, while scanning the cable/satellite EPG (Electronic Program Guide), select a TV show to be recorded, thereby allowing recording of a future or past TV show. The cable (or satellite) subscriber may select a single TV show to record or may request the BDVR system to record every future show in a series (i.e., “season pass”).

The set top box 130 generates a “Show Request” that includes an identification of the TV show to be recorded in response to the selection 302 of the TV show to record on the remote control device 132, and the BDVR Show Request is transmitted 304 from the subscriber's cable/satellite set-top box 130 to the service provider server 120 in the head-end 121, over the cable (or satellite) television network 114. For example, the Show Request may be transmitted via the backward channel of the cable television network 114 or via a wired or wireless telephone line in the case of a satellite television network. This transmission 304 is accomplished in substantially the same way that cable/satellite television operators receive information related to Video-On-Demand or Pay-Per-View requests from the subscribers. Also included in the Show Request is identification (e.g., serial no.) of the set top box 130, which can be used by the head-end 121 to identify the subscriber sending the Show Request and map the subscriber to a subscriber ID.

Then, the Show Request is transmitted 306 from the service provider server 120 to the video distribution server 102 via the broadband network 112. In one embodiment, the Show Request transmitted to the video distribution server 102 includes, but is not limited to, (i) the name of the TV show, (ii) date/time of cable/satellite broadcast (e.g., in GMT), (iii) the name of the television network (e.g. ABC, Discovery, etc.), (iv) whether the request is for a single TV show or a season pass, and (v) the Subscriber ID of the subscriber making the recording request and other subscriber information (e.g., subscriber name, etc.). Note that the transmission step 306 may not be necessary if the functions of the service provider server 120 and the video distribution server 102 are combined into a single server. Also note that the transmission step 306 may occur over a LAN or some other communication channel rather than the broadband network 112, if the video distribution server 102 and the service provider server 120 are located nearby or if the BDVR functions are provided by the same entity that provides the cable (or satellite) television services.

The video distribution server 102 (BDVR application 142) receives 306 the Show Request and interprets the Show Request to find 308 a matching Show ID entry in its video database 140. As explained above, the video database 140 contains a number of entries, called “Playlists” for TV shows that have been listed in the video DB 140. In one embodiment, a playlist may also include other promotional video file(s) associated with the corresponding TV show. The video distribution server 102 (BDVR application 142) also finds 308 a User ID of the BDVR system that matches the subscriber ID or subscriber name passed to it in the Show Request, in the user database 138. Note that in embodiments where the cable (or satellite) service provider's subscription information is used as the registration information for the BDVR service (see e.g., step 204 in FIG. 2), there may not be a need for finding a user ID matching the subscriber ID.

Once the video distribution server 102 (BDVR application 142) finds 308 a matching Show ID and a matching user ID, the video distribution server 102 (BDVR application 142) posts 310 a new item to the user's personal RSS feed 152. The new RSS item includes an RSS Enclosure, which includes the valid Internet-accessible address (e.g., URL) of a video file that the video database 140 has associated with the Show ID. Such video file is stored in one or more video file source servers 150. This is possible because many broadcast and cable networks offer access to video files containing full episodes of their television shows on the Internet. The video file address in the RSS enclosure may point to the video file maintained on the broadcast/cable networks' own servers or in any other Internet-accessible location, even including a file store managed by the BDVR service provider itself. Thus, the video file source server 150 may be operated by an independent entity, by the BDVR service entity itself operating the video distribution server 102, or the head-end 121, or a combination of one or more of these entities. At the time the new RSS item is posted 310 to the user's personal RSS feed 152, the BDVR operator may include other video items in the RSS feed, such as previews of future television shows, summaries of past television shows, video clips, thumbnail images corresponding to the television show, advertisements, promotional material, etc.

On the user's computer 100, the RSS reader 154 maintains a subscription to the personal RSS feed 152. Through this RSS subscription, the user's computer 100 receives periodic updates 312 related to Show Requests described previously. The RSS updates include descriptive information about the Show Request and the newly posted location of the video file source server 150 storing the video file corresponding to the Show Request. Then, the RSS reader 154 downloads 314 the video file corresponding to the Show Request from the video file source server 150 via the broadband Internet network 112. The RSS reader may be configured to perform such download 314 immediately, at an idle time of the computer, at “off-hours” (during the night), in the background of an active application running on the computer 100, or the like. In this manner, the computer 100 may download large video files without affecting the performance of the computer 100 during active use.

Video files received through the BDVR service may be instantly viewed 316 on the user's computer 100 without the need for further downloads. When the user plays 316 the video file using, for example, a video player software incorporated in the RSS reader 154, video play information may be transmitted 322 from the computer 100 to the video distribution server 102 when the computer 100 is next connected to the video distribution server 102. Such video play information may include the identification of the video file that was played on the computer 100, the time at which the video file was played, the number of times the video file was played, etc. The video play information may be further transmitted 324 to the service provider server 120 of the head-end 121, for use in advertisement or marketing purposes.

The downloaded video files may also be copied 318 to portable media players 104, 164 through synchronization mechanisms that may be incorporated into the RSS reader 154 itself, for viewing 319 of the video file on the portable media player using video player software. The synchronization software may also be additionally configured to store video play information on the portable media player 104 and transmit 320 such video play information 320 to the computer 100 when the portable media player 104 next goes through a synchronization process with the computer 100. Again, such video play information may include the identification of the video file that was played on the portable media player 104, the time at which the video file was played, the number of times the video file was played, etc. Such video play information from the portable media player 104 may also be further transmitted 322 from the computer 100 to the video distribution server 102, and further transmitted 324 from the video distribution server 102 to the service provider server 120 of the head-end 121, for use in advertisement or marketing purposes.

Note that the RSS reader 154 may be a standard RSS reader, and may be used to subscribe to any of the tens of thousands of other video RSS feeds that are not part of the BDVR system of the present invention. Also note that the RSS feed 152 may be in a standard RSS feed format, and may be accessed with other standard RSS readers.

The RSS reader 154 may includes an integrated BDVR guide to other RSS feeds (TV shows) available in the BDVR System (other than the user's personal RSS feed 152). The BDVR guide may be updated centrally and/or periodically by the BDVR application 142 with new TV show information and promotions. BDVR users may initiate Show Requests from the BDVR Guide just as they initiate Show Requests from the BDVR-enabled cable or satellite service, using the remote control device 132.

The BDVR service according to the present invention enables users to conveniently select a television show they would like to record via a conventional television network but automatically download a digital video file corresponding to that television show to their computer or portable media player via a broadband Internet network without complicated user interaction. The users can conveniently record and play the video file on their computers without having to search for the video files on the Internet.

The methods of the present invention as described variously in FIGS. 2 and 3 can be implemented in the form of computer software or a computer program product including computer instructions adapted to cause a computer to perform such methods. Such computer software or computer program product may be stored in any type of computer readable storage medium, and such computer instructions may be executed by a processor of a computer. The computer may be any type of computer, including personal computers, general purpose computers, servers, personal digital assistants, smartphones (including both computing functions and cellular telephone functions), media players (e.g., mp3 music players or video players), cellular telephones with some computing functionality, etc. Therefore, the present invention is not limited to the type of hardware in which the methods are performed.

Upon reading this disclosure, those of ordinary skill in the art will appreciate still additional alternative structural and functional designs for a system and a process for a broadband digital video recorder through the disclosed principles of the present invention. Thus, while particular embodiments and applications of the present invention have been illustrated and described, it is to be understood that the invention is not limited to the precise construction and components disclosed herein. Various modifications, changes and variations which will be apparent to those skilled in the art may be made in the arrangement, operation and details of the method and apparatus of the present invention disclosed herein without departing from the spirit and scope of the invention as described herein.

What is claimed is:

1. In a first computer, a computer-implemented method comprising:
receiving at the first computer a selection of a television show to record;
determining a location of a second computer at which the video file corresponding to the selected television show is stored; and
transmitting the location of the second computer from the first computer to a third computer for the third computer to download the video file from the second computer to the third computer, the third computer remote from the first computer and from the second computer.

2. The method of claim 1, wherein the selection of the television show is received at the first computer through a cable television network or a satellite television network.

3. The method of claim 2, wherein the selection of the television show is received at a set-top box used with the cable television network or the satellite television network.

4. The method of claim 2, wherein the selection of the television show is received at the first computer together with a subscriber identification of the cable television network or the satellite television network.

5. The method of claim 4, further comprising determining a user identification at the first computer corresponding to the subscriber identification of the cable television network or the satellite television network.

6. The method of claim 1, wherein the location of the second computer comprises a URL (Universal Resource Locator) of the second computer on the Internet.

7. The method of claim 1, wherein the video file is downloaded from the second computer to the third computer via a broadband Internet network.

8. The method of claim 1, wherein the second computer is remote from the first computer.

9. The method of claim 1, wherein the location of the second computer is transmitted from the first computer to the third computer via an RSS feed running on the first computer and an RSS reader running on the third computer.

10. The method of claim 8, wherein the RSS reader is configured to download the video file from the second computer to the third computer.

11. The method of claim 1, wherein the video file is further transmitted from the third computer to a portable media player via a local communication link.

12. The method of claim 1, wherein the video file is further transmitted from the third computer to a portable media player via a broadband Internet network.

13. The method of claim 1, further comprising receiving video play information corresponding to the video file at the first computer from the third computer.

14. The method of claim 13, further comprising transmitting the video play information to a fourth computer associated with a television service provider.

15. A first computer system comprising a computer readable storage medium including:
a video database storing a list of a plurality of video files corresponding to a plurality of television shows available for downloading from one or more second computers, together with the locations of the second computers;
a computer program including computer instructions adapted to cause a processor of the first computer system to perform a computer-implemented method including:
receiving at the first computer a selection of a television show to record;
determining a location of one or more of the second computers at which a video file corresponding to the selected television show is stored; and
transmitting the location of said one or more of the second computers from the first computer to a third computer for the third computer to download the video file from said one or more of the second computers to the third computer, the third computer remote from the first computer and from the second computer.

16. The first computer system of claim 15, wherein the selection of the television show is received at the first computer system through a cable television network or a satellite television network.

17. The first computer system of claim 16, wherein the selection of the television show is received at a set-top box used with the cable television network or the satellite television network.

18. The first computer system of claim 16, wherein the selection of the television show is received at the first computer system together with a subscriber identification of the cable television network or the satellite television network.

19. The first computer system of claim 18, wherein the method further includes determining a user identification at the first computer corresponding to the subscriber identification of the cable television network or the satellite television network.

20. The first computer system of claim 15, wherein the location of the second computer comprises a URL (Universal Resource Locator) of said one or more of the second computers on the Internet.

21. The first computer system of claim 15, wherein the video file is downloaded from the second computer to the third computer via a broadband Internet network.

22. The first computer system of claim 15, wherein the second computer is remote from the first computer system.

23. The first computer system of claim 15, wherein the computer readable storage medium further includes an RSS feed configured to transmit the location of said one or more of the second computers from the first computer system to an RSS reader running on the third computer.

24. The first computer system of claim 23, wherein the RSS reader is configured to download the video file from said one or more of the second computers to the third computer.

25. The first computer system of claim 15, wherein the video file is further transmitted from the third computer to a portable media player.
